(19) United States
(12) Patent Application Publication
(10) Pub. No.: US 2011/0025786 A1
(43) Pub. Date: Feb. 3, 2011

(54) INK RESERVOIR WITH A BIASING VALVE

(76) Inventor: Brian G. Price, Pittsford, NY (US)

Correspondence Address: Peter P. Hernandez;Patent Legal Staff, Eastman Kodak Company, 343 State Street, Rochester, NY, 14650-2201, US

(21) Appl. No.: 12/511,326

(22) Filed: Jul. 29, 2009

(51) Int. Cl. B41J 2/175

(52) U.S. Cl. 347/85

(57) ABSTRACT

An ink reservoir that contains ink and is detachably mountable to a printhead, the ink reservoir includes a free ink chamber for containing the ink; a valve assembly extending into the free ink chamber and including a first position for permitting ink to flow from the ink reservoir and a second position for stopping the flow of ink from the ink reservoir; and a wick that receives ink from the ink reservoir for transfer to the printhead.

### FIELD OF THE INVENTION

The present invention relates generally to the field of ink reservoirs and, more particularly, to ink tanks for inkjet printers having a biasing valve for more efficiently permitting and stopping the flow of ink to a wick.

### BACKGROUND OF THE INVENTION

An inkjet printer typically includes one or more printheads and their corresponding ink supplies. A printhead includes an array of drop ejectors, each ejector consisting of an ink chamber, an ejecting actuator and a nozzle through which droplets of ink are ejected. The ejecting actuator may be one of various types, including a heater that vaporizes some of the ink in the chamber in order to propel a droplet out of the nozzle, or a piezoelectric device which changes the wall geometry of the chamber in order to generate a pressure wave that ejects a droplet. The droplets are typically directed toward paper or other recording medium in order to produce an image according to image data that is converted into electronic firing pulses for the drop ejectors as the print medium is moved relative to the printhead.

Ink is provided to the printhead through an inlet port of the printhead. In some printers, the corresponding ink supply can be located remotely from the printhead and connected to it, for example by tubing. Alternatively in other printers, an ink supply, also called an ink tank or ink reservoir, can be directly coupled to the printhead. For the case of ink tanks being mounted on the carriage of a carriage printer, the ink tank can be permanently mounted onto the printhead, so that the printhead needs to be replaced when the ink is depleted, or the ink tank can be detachably mounted onto the printhead, so that only the ink tank itself needs to be replaced when the ink tank is depleted. Carriage mounted ink tanks typically contain only enough ink for up to about several hundred prints. This is because the total mass of the carriage needs be limited, so that accelerations of the carriage at each end of the travel do not result in large forces that can shake the printer back and forth. As a result, users of carriage printers having detachably mounted ink tanks need to replace the ink tanks periodically, depending on their printing usage, typically several times per year. An ink tank design facilitating easy and clean installation of a detachable ink tank is beneficial.

One type of detachable ink tank includes a porous member (also called a wick or scavenger member) at the ink outlet port. The printhead inlet port can include a standpipe, for example, with a filter member at its inlet end. When the ink tank is mounted onto the printhead, the ink tank wick is held in contact with the filter member on the standpipe of the printhead inlet port. Once the printhead is primed so that liquid ink fills the various ink passageways between the wick and the nozzles on the printhead, capillary provide the force necessary to supply the ink as needed for printing. Such an ink tank facilitates easy and clean installation onto the printhead

In prior art ink tanks that include a wick, capillary media such as felt or foam is used to retain ink inside the ink tank and provide a slight negative ink pressure so that ink does not drip out of the nozzles of the printhead. This ink-retaining capillary media thus serves as a pressure regulator and provides ink to the wick at the ink outlet port.

It has been found that pigment particles in a pigmented ink can settle out in ink tank designs where ink is stored in a capillary media pressure regulator, partly due to the restriction of motion of pigment particles within the small passages of the capillary media, as described in more detail in U.S. patent application Ser. No. 12/139,533. Such settling of pigments particles, especially for larger pigment particles (e.g. larger than 30 nanometers), can result in defective images during the printing process. As a result, an ink tank using capillary media to store ink can lead to a limitation in pigment particle size that can be used. Such a limitation can be disadvantageous, because such larger particles can be beneficial for providing higher optical density in printed regions.

Consequently, a need exits for an ink tank that facilitates easy and clean installation onto the printhead, but that does not store ink in capillary media.

### SUMMARY OF THE INVENTION

The present invention is directed to overcoming one or more of the problems set forth above. Briefly summarized, according to one aspect of the invention, the invention resides an ink reservoir that contains ink and is detachably mountable to a printhead, the ink reservoir includes a free ink chamber for containing the ink; a valve assembly extending into the free ink chamber and including a first position for permitting ink to flow from the ink reservoir and a second position for stopping the flow of ink from the ink reservoir; and a wick that receives ink from the ink reservoir for transfer to the printhead.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic representation of an inkjet printer system;

FIG. 2 is a perspective view of a portion of a printhead chassis;

FIG. 3 is a perspective view of a portion of a carriage printer;

FIG. 4 is a schematic side view of an exemplary paper path in a carriage printer;

FIG. 5 is a bottom perspective view of a multi-chamber ink reservoir;

FIG. 6 is a top perspective view of a multi-chamber ink reservoir;

FIG. 7 is a perspective view of a printhead chassis without ink tanks mounted;

FIG. 8 is a cross-sectional view of a portion of an ink reservoir, according to a first embodiment, with the valve assembly in the closed position;

FIG. 9A is a close-up cross-sectional view of a portion of an ink reservoir, according to a first embodiment, with the valve assembly in the closed position;

FIG. 9B is a close-up cross-sectional view of a portion of an ink reservoir, according to a first embodiment, with the valve assembly in the open position;

FIG. 10 is a cross-sectional view of a portion of an ink reservoir, according to a first embodiment, with the valve assembly in the open position;

FIG. 11 is a cross-sectional view of a portion of an ink reservoir, according to a second embodiment; and

FIG. 12 is a cross-sectional view of a portion of an ink reservoir, according to a third embodiment.

### DETAILED DESCRIPTION OF THE INVENTION

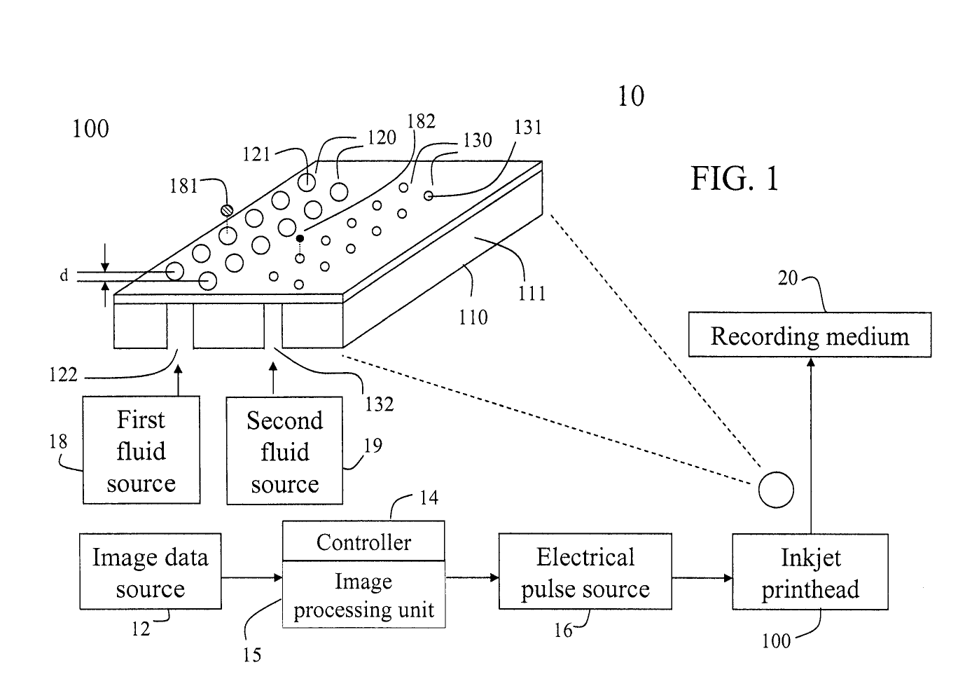

Referring to FIG. 1, a schematic representation of an inkjet printer system 10 is shown for its usefulness with the present invention and is fully described in U.S. Pat. No. 7,350,902, which is incorporated by reference herein in its entirety. Inkjet printer system 10 includes an image data source 12, which provides data signals that are interpreted by a controller 14 as being commands to eject drops. Controller 14 includes an image processing unit 15 for rendering images for printing, and outputs signals to an electrical pulse source 16 of electrical energy pulses that are inputted to an inkjet printhead 100, which includes at least one inkjet printhead die 110.

In the example shown in FIG. 1, there are two nozzle arrays. Nozzles 121 in the first nozzle array 120 have a larger opening area than nozzles 131 in the second nozzle array 130. In this example, each of the two nozzle arrays has two staggered rows of nozzles, each row having a nozzle density of 600 per inch. The effective nozzle density in each array is 1200 per inch (i.e. d= 1/1200 inch in FIG. 1). If pixels on the recording medium 20 were sequentially numbered along the paper advance direction, the nozzles from one row of an array would print the odd numbered pixels, while the nozzles from the other row of the array would print the even numbered pixels.

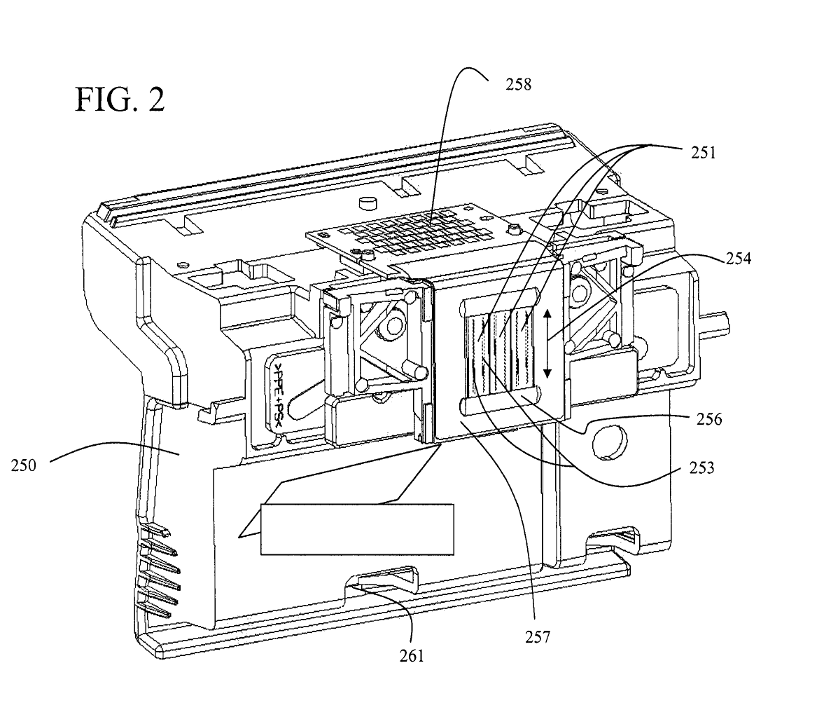

In fluid communication with each nozzle array is a corresponding ink delivery pathway. Ink delivery pathway 122 is in fluid communication with the first nozzle array 120, and ink delivery pathway 132 is in fluid communication with the second nozzle array 130. Portions of ink delivery pathways 122 and 132 are shown in FIG. 1 as openings through printhead die substrate 111. One or more inkjet printhead die 110 will be included in inkjet printhead 100, but for greater clarity only one inkjet printhead die 110 is shown in FIG. 1. The printhead die are arranged on a support member as discussed below relative to FIG. 2. In FIG. 1, first fluid source 18 supplies ink to first nozzle array 120 via ink delivery pathway 122, and second fluid source 19 supplies ink to second nozzle array 130 via ink delivery pathway 132. Although distinct fluid sources 18 and 19 are shown, in some applications it may be beneficial to have a single fluid source supplying ink to both the first nozzle array 120 and the second nozzle array 130 via ink delivery pathways 122 and 132 respectively. Also, in some embodiments, fewer than two or more than two nozzle arrays can be included on printhead die 110. In some embodiments, all nozzles on inkjet printhead die 110 can be the same size, rather than having multiple sized nozzles on inkjet printhead die 110.

Not shown in FIG. 1, are the drop forming mechanisms associated with the nozzles. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

FIG. 2 shows a bottom perspective view of a portion of a printhead chassis 250, which is an example of an inkjet printhead 100. Printhead chassis 250 includes three printhead die 251 (similar to printhead die 110 in FIG. 1), each printhead die 251 containing two nozzle arrays 253, so that printhead chassis 250 contains six nozzle arrays 253 altogether. The six nozzle arrays 253 in this example can each be connected to separate ink sources (not shown in FIG. 2); such as cyan, magenta, yellow, text black, photo black, and a colorless protective printing fluid. Each of the six nozzle arrays 253 is disposed along nozzle array direction 254, and the length of each nozzle array along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving printhead chassis 250 across the recording medium 20. Following the printing of a swath, the recording medium 20 is advanced along a media advance direction that is substantially parallel to nozzle array direction 254.

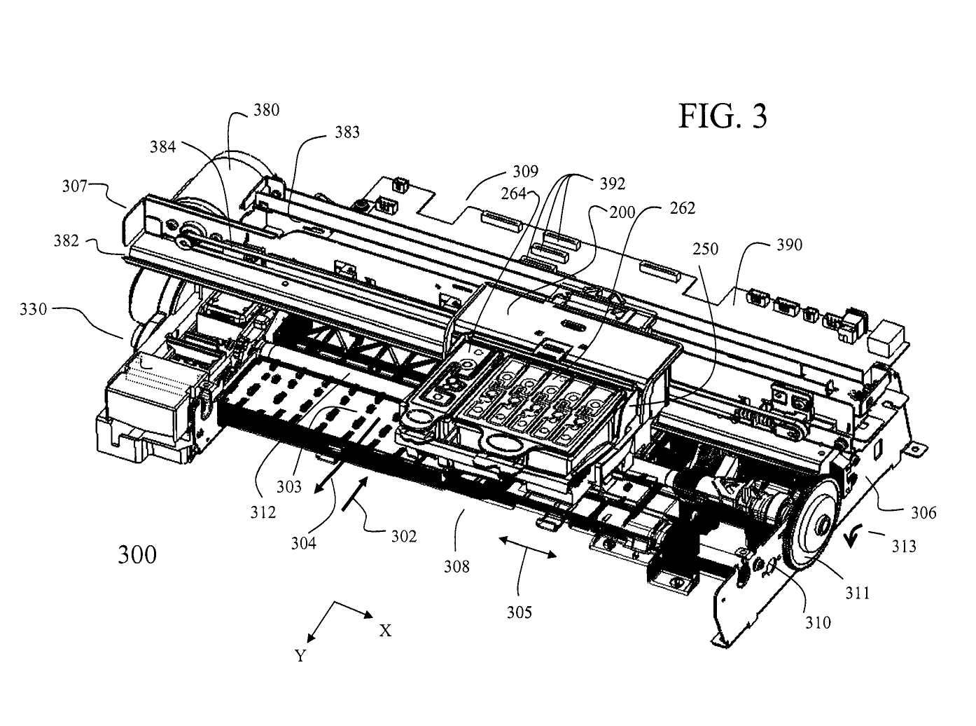

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of printhead chassis 250 and connects to connector board 258. When printhead chassis 250 is mounted into the carriage 200 (see FIG. 3), connector board 258 is electrically connected to a connector (not shown) on the carriage 200, so that electrical signals can be transmitted to the printhead die 251.

As described below, one or more ink reservoirs (also called ink tanks herein) are detachably mountable in printhead chassis 250. In the bottom perspective view of FIG. 2, a ledge on printhead chassis 250 is provided as a catch 261 to engage with a latch on an ink tank (not shown in FIG. 2). When catch 261 is engaged with the latch on an ink tank, the ink tank is held in its mounted position.

FIG. 3 shows a portion of a desktop carriage printer. Some of the parts of the printer have been hidden in the view shown in FIG. 3 so that other parts can be more clearly seen. Printer chassis 300 has a print region 303 across which carriage 200 is moved back and forth in carriage scan direction 305 along the X axis, between the right side 306 and the left side 307 of printer chassis 300, while drops are ejected from printhead die 251 (not shown in FIG. 3) on printhead chassis 250 that is mounted on carriage 200. Carriage motor 380 moves belt 384 to move carriage 200 along carriage guide rail 382. An encoder sensor (not shown) is mounted on carriage 200 and indicates carriage location relative to an encoder fence 383.

Printhead chassis 250 is mounted in carriage 200, and multi-chamber ink reservoir 262 and single-chamber ink reservoir 264 are mounted in the printhead chassis 250. When the ink reservoirs 262 and 264 are mounted in the printhead chassis 250, as in FIG. 3, the combined assembly of printhead chassis 250 and ink reservoirs 262 and 264 is called an inkjet printhead assembly. The mounting orientation of printhead chassis 250 is rotated relative to the view in FIG. 2 so that the printhead die 251 are located at the bottom side of printhead chassis 250, the droplets of ink being ejected downward onto the recording medium in print region 303 in the view of FIG. 3. Multi-chamber ink reservoir 262, in this example, contains five ink sources: cyan, magenta, yellow, photo black, and colorless protective fluid; while single-chamber ink reservoir 264 contains the ink source for text black. Paper or other recording medium (sometimes generically referred to as paper or media herein) is loaded along paper load entry direction 302 toward the front of printer chassis 308.

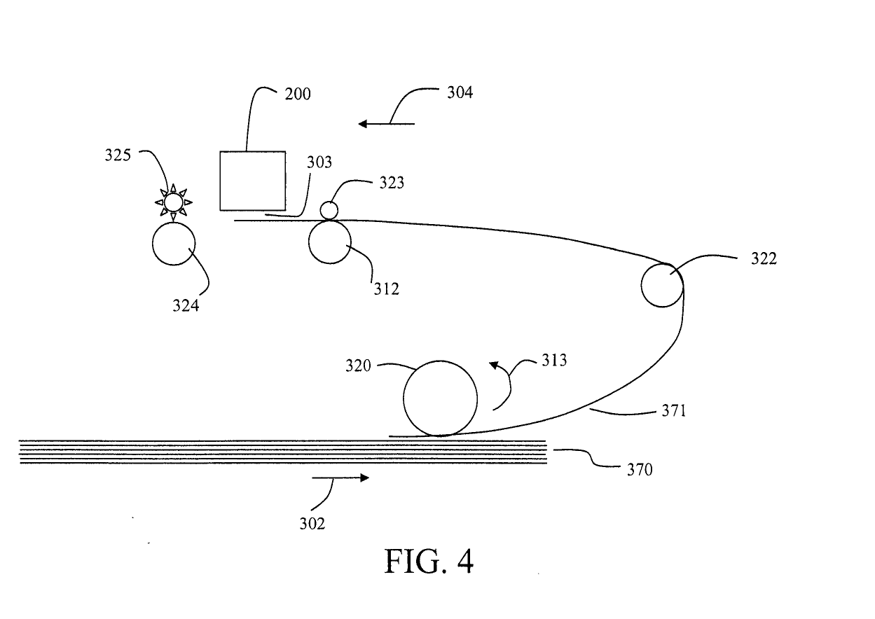

A variety of rollers are used to advance the medium through the printer as shown schematically in the side view of FIG. 4. In this example, a pick-up roller 320 moves the top piece or sheet 371 of a stack 370 of paper or other recording medium in the direction of arrow, paper load entry direction 302. A turn roller 322 acts to move the paper around a C-shaped path (in cooperation with a curved rear wall surface) so that the paper continues to advance along media advance direction 304 from the rear 309 of the printer chassis (with reference also to FIG. 3). The paper is then moved by feed roller 312 and idler roller(s) 323 to advance along the Y axis across print region 303, and from there to a discharge roller 324 and star wheel(s) 325 so that printed paper exits along media advance direction 304. Feed roller 312 includes a feed roller shaft along its axis, and feed roller gear 311 (see FIG. 3) is mounted on the feed roller shaft. Feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 3, but the hole 310 at the right side of the printer chassis 306 is where the motor gear (not shown) protrudes through in order to engage feed roller gear 311, as well as the gear for the discharge roller (not shown). For normal paper pick-up and feeding, it is desired that all rollers rotate in forward rotation direction 313. Toward the left side of the printer chassis 307, in the example of FIG. 3, is the maintenance station 330.

Toward the rear of the printer chassis 309, in this example, is located the electronics board 390, which includes cable connectors 392 for communicating via cables (not shown) to the printhead carriage 200 and from there to the printhead chassis 250. Also on the electronics board are typically mounted motor controllers for the carriage motor 380 and for the paper advance motor, a processor and/or other control electronics (shown schematically as controller 14 and image processing unit 15 in FIG. 1) for controlling the printing process, and an optional connector for a cable to a host computer.

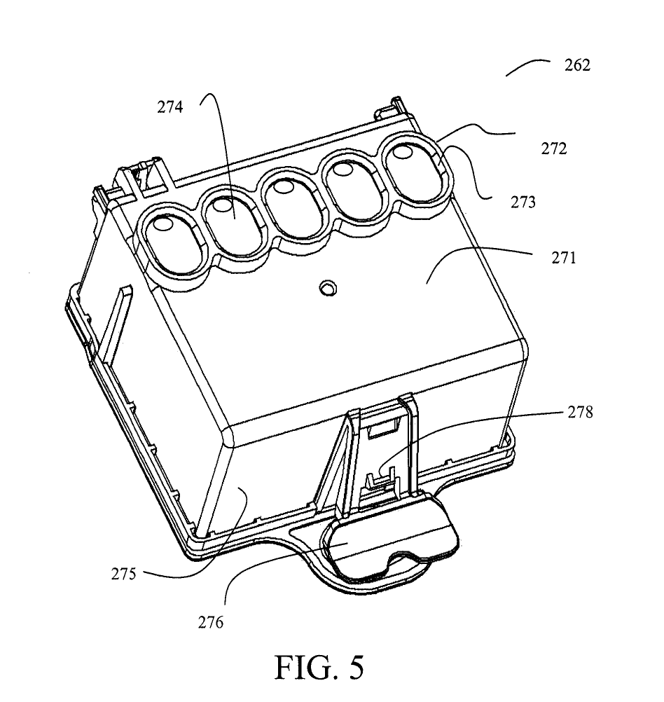

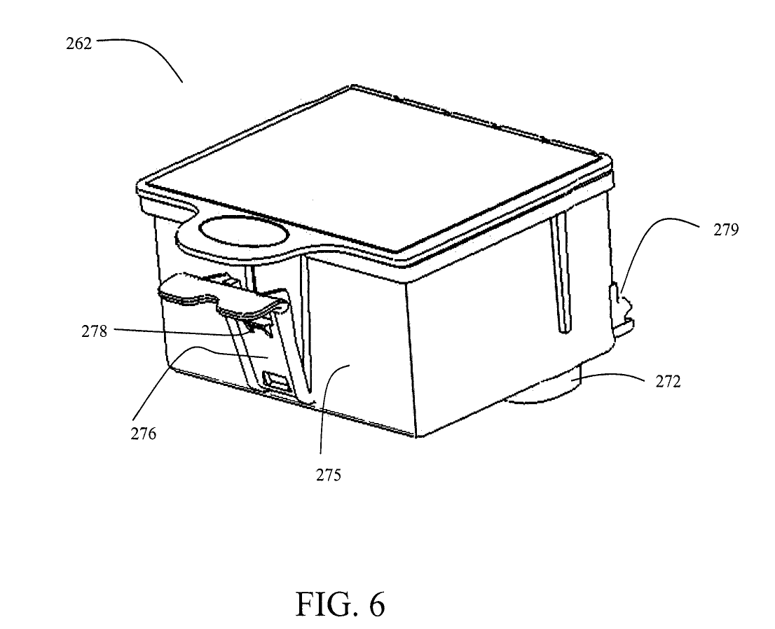

FIG. 5 shows a bottom perspective view and FIG. 6 shows a top perspective view of multi-chamber ink reservoir 262. Five outlet ports 272 (each corresponding to an ink source) extend from a bottom surface of multi-chamber ink reservoir 262. Each outlet port 272 has an outlet opening 273, which is oval-shaped in the example of FIG. 5. A wick 274 is disposed at each outlet opening 273 for transferring of ink to the corresponding inlet port of printhead chassis 250. Wick 274 is a porous member that can be made of a fibrous material (such as a felted material) or a sintered material (such as a sintered plastic) in various embodiments. A latching lever 276 extends outwardly from a back wall 275 of multi-chamber ink reservoir 262. Latching lever 276 includes a latch 278 that engages with catch 261 on printhead chassis 250 when multi-chamber ink reservoir 262 is mounted onto printhead chassis 250. A guide feature 279 is provided on a wall opposite back wall 275 for guiding multi-chamber ink reservoir 262 into proper position on printhead chassis 250.

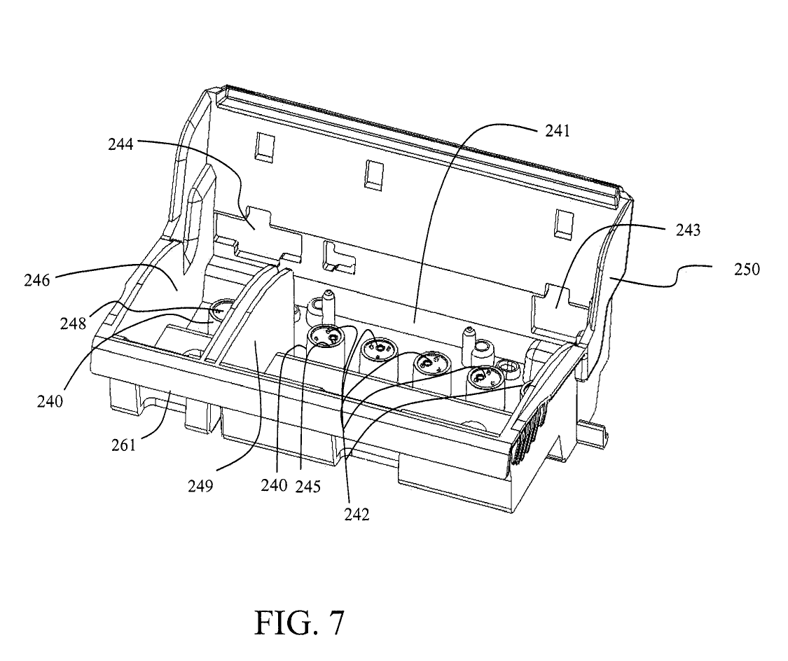

FIG. 7 shows a perspective view of printhead chassis 250 without either replaceable ink tank 262 or 264 mounted onto it. Multi-chamber ink reservoir 262 is mountable in a region 241 and single chamber ink reservoir 264 is mountable in region 246 of printhead chassis 250. Region 241 is separated from region 246 by partitioning wall 249, which can also help guide the ink tanks during installation. Guide feature 279 (see FIG. 6) of multi-chamber ink reservoir 262 is inserted into hole 243 of printhead chassis 250 during mounting of the multi-chamber ink reservoir 262. A similar guide feature (not shown) on single chamber ink reservoir 264 is inserted into hole 244 of printhead chassis 250 during mounting of the single chamber ink reservoir 264. Five inlet ports 242 are shown in region 241 that connect with ink outlet ports 272 (see FIGS. 5 and 6) of multi-chamber ink reservoir 262 when it is installed onto printhead chassis 250, and one inlet port 248 is shown in region 246 for the ink tank port on the single chamber ink reservoir 264. In the example of FIG. 7 each inlet port 242 or 248 has the form of a standpipe 240 that extends from the floor of printhead chassis 250. Typically a filter (such as woven or mesh wire filter, not shown) covers the end 245 of the standpipe 240. The diameter of end 245 of standpipe 240 is smaller than that of the outlet openings 273 (see FIG. 5) of ink reservoir 262 or 264, so that the end 245 of each standpipe 240 is pressed into contact with a corresponding wick 274. When an ink reservoir is installed onto the printhead chassis 250, it is in fluid communication with the printhead because of the connection of the wicks 274 at outlet ports 272 with the ends 245 of standpipes 240 of inlet ports 242 or 248.

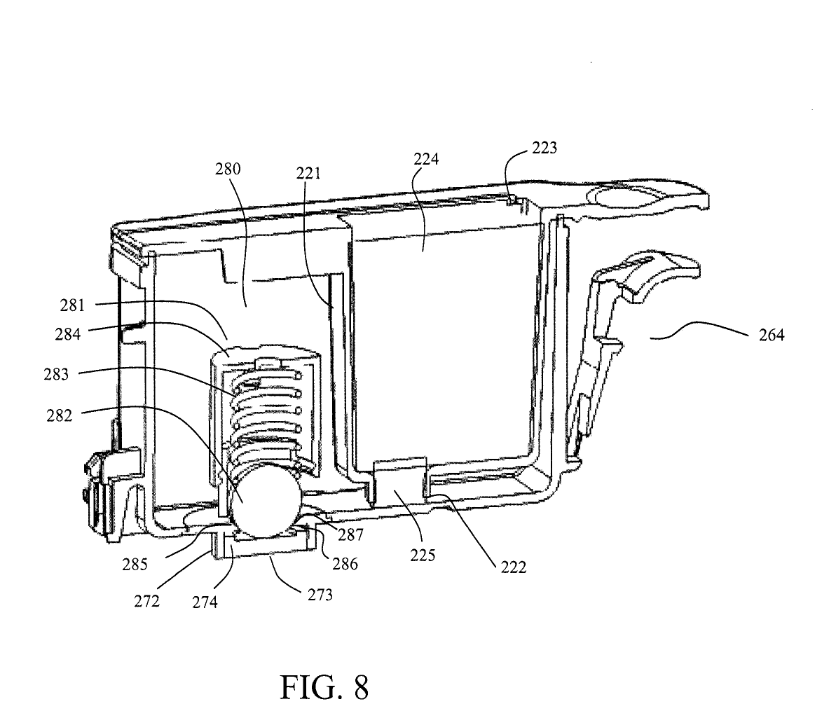

A first embodiment of an ink reservoir according to the present invention is shown in the cross-sectional view FIG. 8. Embodiments will be described with reference to single chamber ink reservoir 264 (see FIG. 3), but the invention is also applicable to the chambers of a multichamber ink reservoir 262 (see FIGS. 3, 5 and 6). The portion of the ink reservoir 264 that is shown in FIG. 8 includes a free ink chamber 280 near outlet port 272. The term “free ink chamber” as used herein means a chamber containing liquid ink that is free to flow (at least within the free ink chamber 280), rather than being stored in a capillary member. Valve assembly 281 extends into free ink chamber 280 to control whether or not ink is permitted to flow from ink reservoir 264. In FIG. 8, valve assembly 281 is in a closed position that does not allow ink to flow from ink reservoir 264. Valve assembly 281 is intended to be in the closed position when the ink reservoir is not mounted onto the printhead. Thus, the user can load or change ink tanks without having ink flowing out of outlet port 272.

Valve assembly 281 in this embodiment includes a ball 282, a compression spring 283, a cap 284, and a sealing face 285. The ball 282 serves as a sealing member that is pressed by compression spring 283 against sealing face 285. The sealing face 285 is a circular rim disposed around the inner portion of the outlet port 272. The sealing face 285 is shaped so that it conforms to the shape of the ball 282 for firmly sealing the ball 282 against the sealing face 285 which, in this closed position, does not permit the ink to flow. Typically some elastic compliance is provided at the sealing interface between the sealing member (ball 282) and the sealing face 285 to provide a reliable seal. For example, ball 282 can be an elastomeric ball that can deform slightly by the pressure exerted by the compression spring 283, in order to seal against sealing face 285. One end of spring 283 is in contact with ball 282, while the opposite end of spring 283 pushes against cap 284. A portion of ball 282, which is opposite where spring 283 contacts ball 282, is in contact with wick 274 that is disposed at the outlet opening 273 of outlet port 272.

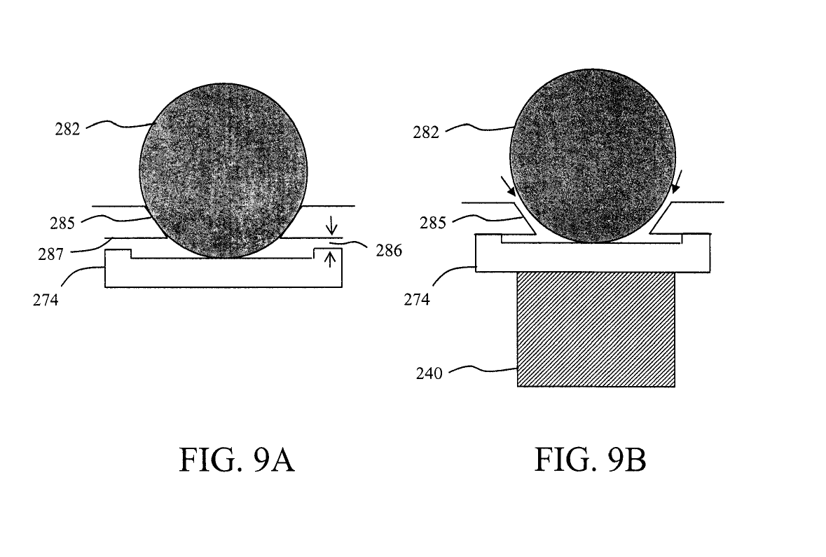

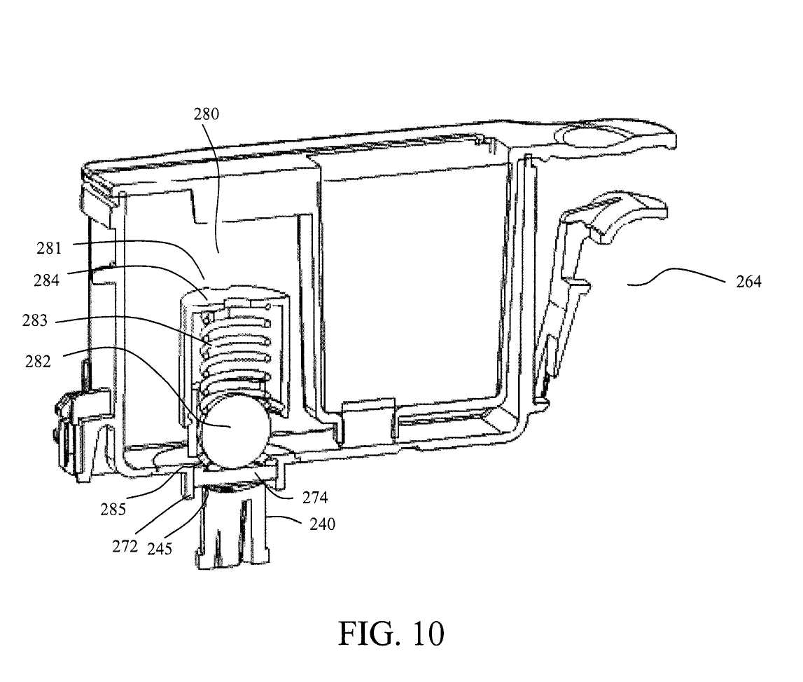

When valve assembly 281 is in the closed position, a space 286 exists between wick 274 and an inner face 287 of outlet port 272, as shown more clearly in the close-up view of FIG. 9A. The space 286 permits the wick 274 to move upwardly when the valve moves from the closed position to the open position (see FIGS. 9B and 10 for open position). It is noted that the space 286 can be approximately 1 mm, for example, when valve assembly 281 is in the closed position.

In the embodiment of FIG. 8, the length of compression spring 283, the diameter of ball 282 and the diameter of the opening at sealing face 285 are designed such that when valve assembly 281 is in the closed position, a portion of ball 282 is in contact with the wick 274 without exerting a large downward force on wick 274. In other words, the downward force on wick 274 is not sufficient to push wick 274 entirely out of outlet port 272. In other embodiments (not shown), when valve assembly 281 is in the closed position, ball 282 is near wick 274, but not quite in contact.

FIGS. 9B and 10 show a cross-sectional view of the embodiment of FIG. 8, but with valve assembly 281 in the open position. Valve assembly 281 is forced into its open position when the ink reservoir 264 is mounted and latched onto printhead chassis 250. As described above (relative to FIGS. 5-7), when ink reservoir 264 is installed onto printhead chassis 250, standpipe 240 at inlet port 248 is pressed into contact with a corresponding wick 274 at outlet port 272 of the ink reservoir. In embodiments of this invention, the position of the wick 274, the guide feature 279, latch 278, and the space 286 between the wick 274 and the inner face 287 of outlet port 272 are designed relative to printhead chassis 250, catch 261 and holes 243 and 244 (FIG. 7), such that when ink reservoir 264 is mounted and latched onto printhead chassis 250, standpipe 240 at inlet port 248 pushes the corresponding wick 274 upwardly into the space 286. Wick 274, as a result, pushes the sealing member (e.g. ball 282) away from sealing face 285 to force valve assembly 281 into the open position. In other words, a gap exists between the ball 282 and the sealing face 285 so that ink flows therebetween and eventually onto the wick 274. Ink flow is indicated by the arrows in FIG. 9B. In the open position shown in FIGS. 9B and 10, the sealing member (e.g. ball 282) is pushed away from sealing face 285 with a force that is greater than the force exerted by compression spring 283. As a result, ink is able to flow from free ink chamber 280 of ink reservoir 264 through the gap between sealing face 285 and displaced ball 282. The ink that flows past open valve assembly 281 is received by wick 274 for transfer to the printhead. In the open position of the valve assembly 281, compression spring 283 of the valve assembly provides a biasing force to push the sealing member (e.g. ball 282) into contact with wick 274 and to hold wick 274 thereby in contact with end 245 of standpipe 240 of corresponding inlet port 248 for providing a suitable flow of ink from the wick 274 into the standpipe 240.

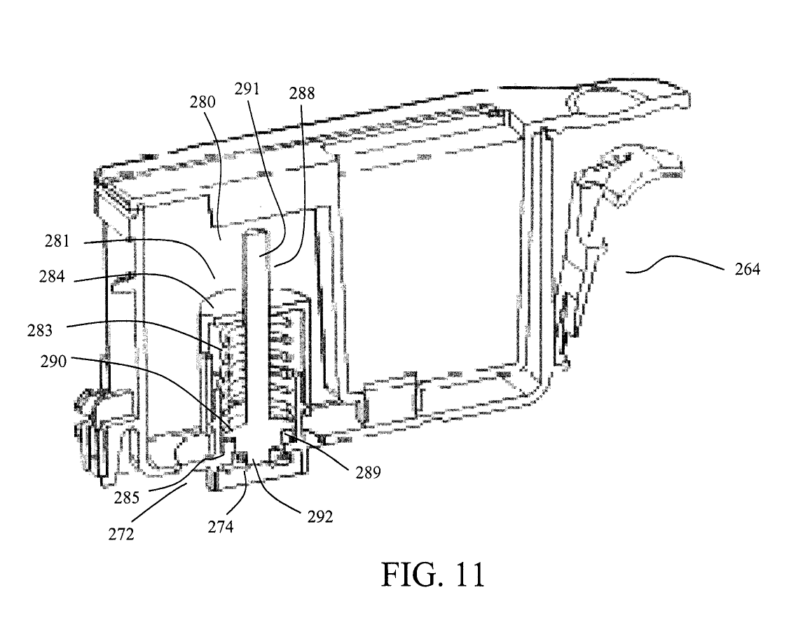

FIG. 11 shows a cross-sectional view of a second embodiment of the invention. In this embodiment, the valve assembly 281 includes a plunger 288, a compression spring 283, a cap 284, an O-ring 289 (that serves as a sealing member), and a sealing face 285. Plunger 288 includes a flange 290 for contacting O-ring 289, a stem 291 that guides the vertical motion of the plunger 288, and an extension 292 that contacts wick 274. As in the first embodiment, valve assembly 281 extends into free ink chamber 280 of ink reservoir 264. Compression spring 283 pushes from cap 284 to plunger 288 so that the flange 290 contacts O-ring 289 and pushes it into sealing contact against sealing face 285 when ink reservoir 264 is not mounted onto printhead chassis 250 and valve assembly 281 is in the closed position as in FIG. 11. Consequently, ink is not permitted to flow since the O-ring 289 is seated firmly against the sealing face 285. Similar to the first embodiment shown in FIGS. 9B and 10 (but not shown in FIG. 11), when ink reservoir 264 is mounted onto the printhead chassis 250, standpipe 240 of inlet port 248 pushes on the corresponding wick 274 into the space 286. Wick 274 pushes on extension 292 of plunger 288 so that plunger 288 and O-ring 289 are displaced away from sealing face 285. This forces valve assembly 281 into its open position and permits ink to flow from free ink chamber 280 to the wick 274 for transfer to the printhead. A guide hole in cap 284 guides stem 291 of plunger 288 so that plunger motion is well controlled. The biasing force of the compression spring 283 is transferred to wick 274 by plunger extension 292 so that the wick 274 is held in contact with the end of the standpipe 240 at corresponding inlet port 242 or 248 of printhead chassis 250 for permitting a suitable flow of the ink from the wick 274 to the standpipe 240.

Wick 274, together with valve assembly 281 and free ink chamber 280 provide easy and clean installation of ink reservoir 264 onto printhead chassis 250 in embodiments of this invention. In addition, even though wick 274 is a porous member, ink is not stored in wick 274 but is constantly refreshed as new ink from the free ink chamber 280 flows through wick 274 printhead chassis 250. Because ink continues to flow through wick 274, pigment particles in a pigmented ink are not caused to settle out of the ink to an extent that printed image quality is thereby degraded, even if the size of the pigment particles is greater than 30 nanometers.

For embodiments of this invention where a pigmented ink is contained in free ink chamber 280, and the pigment particle size is greater than 30 nanometers, it is further advantageous for the pressure regulator in the ink tank to be a type that does not store ink in a capillary medium.

One type of pressure regulator that has been shown not to cause pigment particles to settle out to an extent that image quality is degraded is the pressure regulator described in U.S. patent application Ser. No. 12/139,533, and incorporated herein by reference. The pressure regulator described in U.S. patent application Ser. No. 12/139,533 and shown in FIG. 8 includes an enclosure 221 extending into free ink chamber 280 and having a hole 222 that opens into the free ink chamber 280. A first capillary member 224 is located in the enclosure near a vent 223 that leads to the atmosphere. A second capillary member 225, having a pore size that is less than the pore size of the first capillary member 224, is located in the enclosure 221 adjacent the hole 222 that opens into the free ink chamber 280. Such a pressure regulator excludes ink during normal operating conditions but is able to contain ink, if necessary, as a result of significant pressure excursions (for example, changes in ambient pressure). The second capillary member 225 is in fluidic contact with the ink in the free ink chamber 280 and provides the required amount of negative pressure for proper operation of the printhead, while not storing ink. It has been found that an ink reservoir having such a pressure regulator and the free ink chamber, valve assembly and wick of the present invention does not cause pigment particles to settle out to an extent that image quality is degraded.

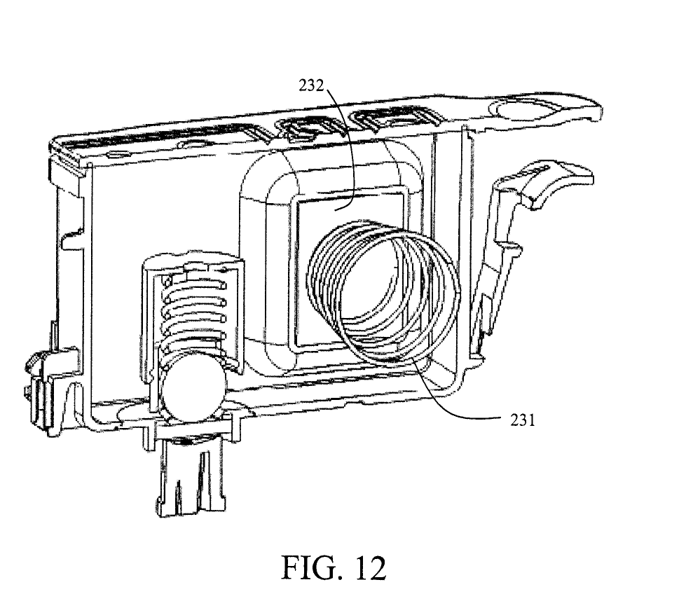

A second type of pressure regulator that can be used with the free ink chamber, valve assembly and wick of the present invention and not cause pigment particles to settle out to an extent that image quality is degraded includes a free ink chamber having a flexible wall member in contact with the free ink. As shown in FIG. 12 (having an open valve configuration similar to FIG. 10), spring 231 is disposed in contact with flexible wall 232 to push the wall in a direction that tends to increase the volume of the free ink chamber 280. The spring 231 can be inside the free ink chamber 280 and push the flexible wall 232 outward, or outside the free ink chamber 280 and pushing the flexible wall 232 inward, as shown in FIG. 12. The free ink chamber 280 can have a single flexible wall 232 plus one or more rigid walls, or it can have the form of a bag, where the flexible wall member is a wall of the ink-containing bag. Such a spring-bag pressure regulator is disclosed, for example, in U.S. Pat. No. 5,359,353.

In summary, embodiments of the present invention have the advantages of providing clean and easy installation of the ink reservoir onto the printhead, providing an appropriate amount of negative ink pressure for proper operation of the printhead, and not causing pigment particles to settle out of the ink to an extent that image quality is degraded.

The invention has been described in detail with particular reference to certain preferred embodiments thereof, but it will be understood that variations and modifications can be effected within the spirit and scope of the invention.

### PARTS LIST

10 Inkjet printer system
12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
221 Enclosure
222 Hole
223 Vent
224 First capillary member
225 Second capillary member
231 Spring
232 Flexible wall
240 Standpipe
241 Region (for mounting multi-chamber ink reservoir)
242 Inlet port
243 Hole
244 Hole
245 End
246 Region (for mounting single chamber ink reservoir)
248 Inlet port
249 Partitioning wall
250 Printhead chassis
251 Printhead die
253 Nozzle array
254 Nozzle array direction
256 Encapsulant
257 Flex circuit
258 Connector board
261 Catch for ink tank latching mechanism
262 Multi-chamber ink reservoir (ink tank)
264 Single-chamber ink reservoir (ink tank)
271 Housing
272 Outlet port
273 Outlet opening
274 Wick
275 Back wall
276 Latching lever
278 Latch
279 Guide feature
280 Free ink chamber
281 Valve assembly
282 Ball
283 Compression spring
284 Cap
285 Sealing face
286 Space
287 Inner face
288 Plunger
289 O-ring
290 Flange
291 Stem
292 Extension
300 Printer chassis
302 Paper load entry direction
303 Print region
304 Media advance direction
305 Carriage scan direction
306 Right side of printer chassis
307 Left side of printer chassis
308 Front of printer chassis
309 Rear of printer chassis
310 Hole (for paper advance motor drive gear)
311 Feed roller gear
312 Feedroller
313 Forward rotation direction (of feed roller)
320 Pick-up roller
322 Turn roller
323 Idler roller
324 Discharge roller
325 Star wheel(s)
330 Maintenance station
370 Stack of media
371 Top piece of medium
380 Carriage motor
382 Carriage guide rail
383 Encoder fence
384 Belt
390 Printer electronics board
392 Cable connectors

1. An ink reservoir that contains ink and is detachably mountable to a printhead, the ink reservoir comprising:
a free ink chamber for containing the ink;
a valve assembly extending into the free ink chamber and including a first position for permitting ink to flow from the ink reservoir and a second position for stopping the flow of ink from the ink reservoir; and
a wick that receives ink from the ink reservoir for transfer to the printhead.

2. The ink reservoir as in claim 1, wherein the wick is disposed in an outlet port for connection to the printhead.

3. The ink reservoir of claim 1, wherein the valve assembly comprises:
a sealing member;
a sealing face that receives the sealing member for stopping ink flow and that is a spaced apart relationship with the sealing member for permitting ink flow; and
a compression spring that biases the sealing member into contact with the wick.

4. The ink reservoir of claim 3, wherein the sealing member comprises a ball.

5. The ink reservoir of claim 1, wherein the valve assembly comprises:
a sealing member;
a sealing face that receives the sealing member for stopping ink flow and that is a spaced apart relationship with the sealing member for permitting ink flow;
a plunger in operative relation to the sealing member;
a compression spring that biases the plunger into contact with the sealing member.

6. The ink reservoir as in claim 1, wherein the valve assembly provides a biasing force on the wick.

7. The ink reservoir as in claim 1 wherein the wick comprises a fibrous material.

8. The ink reservoir of claim 1 wherein the wick comprises a sintered material.

9. The ink reservoir of claim 1 further comprising a pressure regulator for providing a back pressure on the ink.

10. The ink reservoir of claim 9, wherein the pressure regulator comprises a pressure regulation chamber including a capillary media that is in fluidic contact with the ink in the free ink chamber.

11. The ink reservoir of claim 9, wherein the pressure regulator comprises:
a flexible member in contact with free ink; and
a spring in contact with the flexible member for providing pressure regulation.

12. The ink reservoir of claim 11, wherein the flexible member is a wall of an ink-containing bag.

13. The ink reservoir as in claim 1, wherein the ink is pigmented ink having a particle size greater than 30 nanometers.

14. An inkjet printhead assembly comprising:
(a) an inkjet printhead including an ink inlet port; and
(b) an ink reservoir that is detachably mountable to the printhead, the ink reservoir comprising:
(i) a free ink chamber for containing ink;
(ii) a valve assembly extending into the free ink chamber and including a first position for permitting ink to flow from the ink reservoir and a second position for stopping the flow of ink from the ink reservoir;
(iii) an ink outlet port for receiving the ink from the valve assembly and transferring the ink to the ink inlet port of the printhead; and
(iv) a wick disposed at the ink outlet port.

15. The inkjet printhead assembly of claim 14, the ink inlet port comprising a standpipe having an end, wherein the end of the standpipe is in contact with the wick when the ink reservoir is mounted on the ink inlet port of the printhead.

16. The inkjet printhead assembly of claim 15, wherein the ink inlet port further comprises a filter disposed at the end of the standpipe.

17. The inkjet printhead assembly as in claim 14, wherein the valve assembly provides a biasing force on the wick.

18. The inkjet printhead assembly of claim 17 further comprising a latching mechanism to hold the inkjet printhead and the ink reservoir together, wherein when the ink reservoir is mounted to the printhead and the latching mechanism is engaged, the ink inlet port contacts the wick which overcomes the biasing force of the valve assembly to displace the wick.

19. The inkjet printhead assembly of claim 18, wherein when the ink reservoir is mounted on the ink inlet port of the printhead and the latching mechanism is engaged, the valve assembly is forced open, thereby allowing ink to flow to the wick.

20. The inkjet printhead assembly of claim 14, wherein the valve assembly comprises:
a sealing member;
a sealing face that receives the sealing member for stopping ink flow and that is a spaced apart relationship with the sealing member for permitting ink flow; and
a compression spring that biases the sealing member into contact with the wick.

21. The inkjet printhead assembly of claim 20, wherein the sealing member comprises a ball.

22. The inkjet printhead assembly of claim 14, wherein the valve assembly comprises:
a sealing member;
a sealing face that receives the sealing member for stopping ink flow and that is a spaced apart relationship with the sealing member for permitting ink flow;
a plunger in operative relation with the sealing member;
a compression spring that biases the plunger into contact with the sealing member.

23. The inkjet printhead assembly as in claim 14, wherein the wick comprises a fibrous material.

24. The inkjet printhead assembly of claim 14, wherein the wick comprises a sintered material.

25. The inkjet printhead assembly of claim 14 further comprising a pressure regulator for providing a back pressure on the ink.

26. The inkjet printhead assembly of claim 25, wherein the pressure regulator comprises a pressure regulation chamber including a capillary media that is in fluidic contact with the ink in the free ink chamber.

27. The inkjet printhead assembly of claim 25, wherein the pressure regulator comprises:
a flexible member in contact with free ink; and
a spring in contact with the flexible member for providing pressure regulation.

28. The inkjet printhead assembly of claim 27, wherein the flexible member is a wall of an ink-containing bag.

29. The inkjet printhead assembly as in claim 14, wherein the ink is pigmented ink having a particle size greater than 30 nanometers.
